(19) United States
(12) Patent Application Publication
(10) Pub. No.: US 2017/0167720 A1
(43) Pub. Date: Jun. 15, 2017

(54) SOLAR POWERED ILLUMINATION SYSTEMS FOR WEARABLE ARTICLES

(71) Applicant: Thomas E. Mueller, Las Vegas, NV (US)

(72) Inventor: Thomas E. Mueller, Las Vegas, NV (US)

(21) Appl. No.: 14/963,514

(22) Filed: Dec. 9, 2015

(51) Int. Cl. F21V 33/00; A41D 1/04; A41D 13/01; F21S 9/03; F21V 23/04

(52) U.S. Cl. CPC F21V 33/0076; F21S 9/032; F21V 23/0464; F21V 23/0407; A41D 13/01; A41D 1/04; F21Y 2115/10; F21Y 2103/10; F21W 2111/10

(57) ABSTRACT

Illumination systems for wearable articles which include one or more lights, such as LED lights, connected with a rechargeable battery, such as through copper or aluminum wiring, and a solar panel for recharging a rechargeable battery during sufficiently high-light ambient conditions, thus enabling the rechargeable battery to provide power for the illumination system during low-light ambient conditions.

### BACKGROUND OF THE INVENTION

Field of the Invention

The present invention relates to illumination systems which use solar power as a power source and can be incorporated or embedded in articles of clothing such as articles of clothing that can be worn or attached to the body for safety reasons.

Description of the Related Art

Many outdoor activities, recreational and vocational, increase in danger solely due to the lack of visibility during nighttime or even in some daytime conditions. Motorcycles and motorized vehicles are all equipped with battery-powered lights which, when illuminated, make them easier to detect at night or in such conditions. Bicycles also generally have battery-powered lights which can be used to increase the likelihood of they will be detected by others in low-light conditions. None of these illumination systems are intended for use by individuals engaging in outdoor activities apart from a car or bike. Accordingly, it is desirable to provide illumination systems which can be easily adopted for use by individuals.

### SUMMARY OF THE INVENTION

The invention is generally directed to illumination systems for wearable articles which include one or more lights connected with a rechargeable battery and a solar panel for recharging a rechargeable battery during sufficiently high-light ambient conditions, thus enabling the rechargeable battery to provide power for the illumination system during low-light ambient conditions.

In some embodiments, the invention is directed to a wearable article of clothing including mounted therein a solar panel positioned for receiving light and converting the light received into electricity, a rechargeable battery for storing electrical energy, a first set of flexible conductors in electrical communication with an output terminal of the solar panel on a first end and the battery on the second end, one or more lights, a second set of flexible conductors in electrical communication with the battery on a first end and the one or more lights on a second end, and an electrical switch for alternately connecting and disconnecting an electrical circuit including the battery and the one or more lights, wherein the lights illuminate responsive to the electrical circuit being connected by the electrical switch.

In some embodiments, the one or more lights are light emitting diodes.

Some embodiments of the invention are directed to an illumination system incorporated in a wearable article, comprising: an article body; a solar panel mounted on the surface of the body such that at least a portion thereof is exposed to ambient conditions, the solar panel being adapted to convert solar energy into electric energy; a rechargeable battery for receiving electrical energy outputted from the solar panel mounted to the body; one or more lights mounted to the body such that the light emitted from the lights is visible outside of the body when the lights are illuminated; a switch mounted on the body and adapted to alternate between a connected and a disconnected position; and a plurality of conductors in electrical communication with the solar panel, rechargeable battery, one or more lights and switch, wherein the conductors form an electrical circuit responsive to the switch being in the connected position.

In some embodiments, the rechargeable battery is one of a Li-battery, nickel-metal hydride battery, nickel-cadmium battery.

In some embodiments, the wearable article is a garment. The garment may be configured to be worn on the upper body of a human, with the solar panel being positioned on an area of the garment associated with the shoulder of a wearer of the garment. The one or more lights may be mounted in an area of the garment associated with the torso of the wearer of the garment. Additionally, the one or more lights are mounted on the garment in the form of a symbol, such as an arrow, stop or caution signs or symbols, or spell out a word, such a stop or help.

In some embodiments, the one or more lights are configured to illuminate intermittently.

In some embodiments, the illumination system further includes an ambient light sensor for alternately activating and deactivating the one or more lights responsive to detecting ambient light conditions.

Some embodiments of the invention are directed to an illumination system incorporated in a wearable article, comprising: an article body configured to be worn on a human upper body; a solar panel mounted on the surface of the body in an area associated with a shoulder of the wearer of the article body such that at least a portion thereof is exposed to ambient conditions, the solar panel being adapted to convert solar energy into electric energy; a rechargeable battery for receiving electrical energy outputted from the solar panel mounted to the body; one or more lights mounted to the body in an area associated with the torso of the wearer of the article body such that the light emitted from the lights is visible outside of the body when the lights are illuminated; a switch mounted on the body and adapted to alternate between a connected and a disconnected position; and a plurality of conductors in electrical communication with the solar panel, rechargeable battery, one or more lights and switch, wherein the conductors form an electrical circuit responsive to the switch being in the connected position. As discussed above, in some embodiments, the one or more lights are mounted on the body in the form of a symbol or the form of a word.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a schematic diagram of a system constructed in accordance with the invention; and

FIG. 2 is a front view of an article incorporating another embodiment of the system of the invention.

### DETAILED DESCRIPTION OF THE PREFERRED EMBODIMENT

Various embodiments are enabled by the invention, including but not limited to the embodiments described herein. In the following description, numerous specific examples and details are set forth in order to provide a more thorough description of the invention. Thus, it will be apparent to one skilled in the art, that the invention may be practiced without at least some of the specific details provided herein. In other instances, well-known features have not been described in detail so as not to obscure the invention.

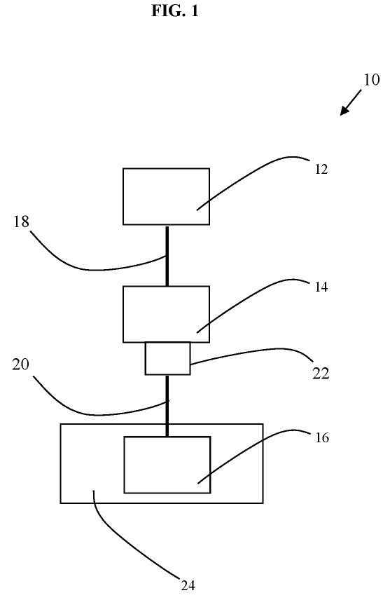

An illumination system constructed and configured in accordance with the invention is shown in FIG. 1 and generally referred to by the reference number 10. Illumination system 10 includes a solar panel 12, a rechargeable battery 14 and a light 16 connected by electrical conductors 18 and 20, respectively, to form an electrical circuit.

System 10 of this embodiment further includes a switch 22 for alternately connecting and disconnecting the electrical circuit resulting in the corresponding activation and deactivation of light 16. Switch 22 may be mounted on or adjacent to battery 14.

In some embodiments, switch 22 is manually switched between connected and disconnected states whereas in other embodiments switch 22 is an ambient light detector configured to automatically switch to the connected state based on a detection of low ambient light conditions.

It should be understood that electrical conductors 18 and 20 may be constructed of any electrically conductive material, such as copper, but may also be made of aluminum, and may be cylindrical or flat.

Rechargeable battery 14 may be any power storage or capacitor, and may be a lithium battery, nickel-metal hydride battery or nickel-cadmium battery. It should be understood that system 10 may further include duplicate components, such as more than one solar panel 12 and more than one battery 14.

In this embodiment, lights 16 are disposed on a substrate 24. Substrate 24 may be made of a rigid or flexible material. In some embodiments, substrate 24 includes a fastener, such as an adhesive strip, hook-and-loop fastener, touch fastener, fastener or other closure for temporarily or permanently fastening substrate 24 to another article or body.

In some embodiments, battery 14 is configured to power lights 16 such that lights 16 blink intermittently. When battery 14 is drained below a threshold potential energy level lights 16 cease blinking and remain steady as an indicator that battery 14 is low until eventually turning off due to a lack of battery power from battery 14.

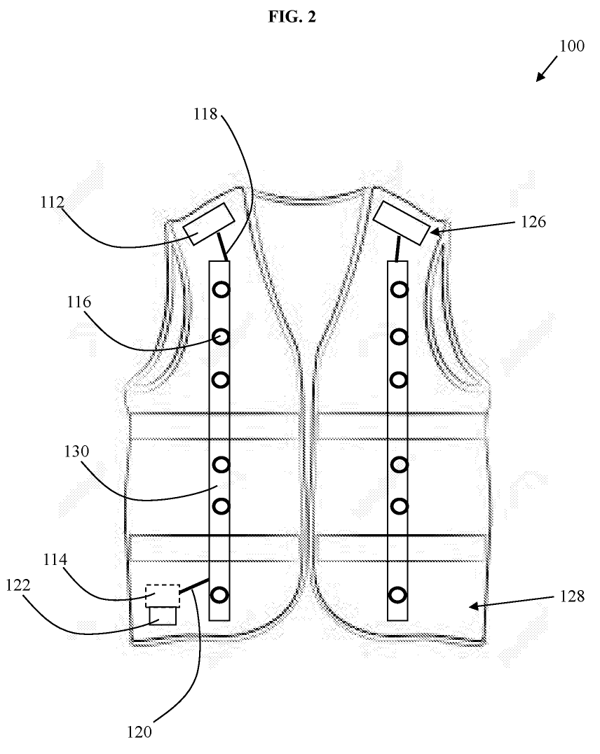

FIG. 2 illustrates an article 100 constructed to include an illumination system 110. Article 100 is intended to be worn as a vest for safety and can be constructed of any material, such as a polyester, nylon, vinyl, cotton, or combinations thereof, and may particularly be made of or otherwise include brightly colored neon and reflective materials. It should be understood that article 100 is not limited to a vest and the invention is applicable to any of a variety of other forms as well.

Article 100 includes a partially exposed solar panel 112 mounted in the shoulder area of article 100, that is, in an upper area 126 which would normally rest upon the shoulder of a user of article 100. Solar panel 112 is electrically connected with battery 114 which is mounted on article 100. Battery 114 may be mounted anywhere on article 100 but in this embodiment is mounted in a lower area 128 of article 100 that would rest upon the waist of the user. Lights 116 are mounted along an elongated strip 130 generally extending from the lower area 128 to the upper area 126. Electrical conductors 118 and 120 (partially shown) extend from lower area 128 to upper area 126 to form an electrical circuit which is connected for electrical flow responsive to switch 122 being switched to the on position by the user.

Lights 116 may be a series of light emitting diodes (LEDs) mounted on strip 130 of any color or colors to provide for high brightness illumination.

In some embodiments, lights 116 may include multiple sets of lights or LEDs, which may also be symmetrically arranged on article 100 or arranged to form a symbol or word on article 100 to use system 110 to send a signal or message via lights 116. This may be particularly useful in low light conditions and/or noisy conditions in which visual messages provided by lights 116 may be easier to convey than vocal messages. Lights 116 on article 100 may be visible from much farther away than article 100 without lights, even if article 100 includes reflective material.

When illumination is not necessary, such as during the day, switch 122 is switched to the off position to disconnect the electrical circuit so that no electricity is received by lights 116. However, switch 122 is not configured to connect or disconnect the electrical connection between solar panel 112 and battery 114. During the day when switch 122 is in the off position, electrical energy generated by solar panel 112 is therefore directed to and stored in rechargeable battery 114. When illumination of lights 116 is necessary, such as during night, switch 122 is switched to the on position to connect the circuit formed by electrical connectors 120, thereby causing the lights 116 to receive power from battery 114 and emit light.

According to the present invention, system 10 and article 100 provides for protection and safety to an individual engaging in outdoor activity during low-light conditions. This can be the difference between life and death in certain occupations such as highway construction which often takes place at night during which individuals work immediately adjacent to vehicles moving at high rates of speed.

Further, the system 10 consumes solar power as the power source for the light. Solar power is a pure, safe and free natural resource, and its supply is unlimited and its utilization is endless, particularly in southwestern parts of the United States. Therefore, utilization of solar power is economic and environmentally friendly.

The systems of the invention are adapted for installation and use on a number of wearable articles, such as, headwear (e.g., construction helmets, mining helmets, motorcycle helmets, biking helmets, baseball caps, cloth caps, hoods), outwear (coats, jackets, vests), footwear (boots, shoes), and sporting wear (uniforms, belts), as well as for pets (dog collars for example), among other things.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the disclosure of the invention herein and as set forth in the claims and equivalents thereto.

1. An illumination system incorporated in a wearable article, comprising:
an article body;
a solar panel mounted on the surface of the body such that at least a portion thereof is exposed to ambient conditions, the solar panel being adapted to convert solar energy into electric energy;
a rechargeable battery for receiving electrical energy outputted from the solar panel mounted to the body;
one or more lights mounted to the body such that the light emitted from the lights is visible outside of the body when the lights are illuminated;
a switch mounted on the body and adapted to alternate between a connected and a disconnected position; and
a plurality of conductors in electrical communication with the solar panel, rechargeable battery, one or more lights and switch, wherein the conductors form an electrical circuit responsive to the switch being in the connected position.

2. The illumination system as recited in claim 1, wherein the rechargeable battery is one of a Li-battery, nickel-metal hydride battery, nickel-cadmium battery.

3. The illumination system as recited in claim 1, wherein the wearable article is a garment.

4. The illumination system as recited in claim 3, wherein the garment is configured to be worn on the upper body of a human.

5. The illumination system as recited in claim 4, wherein the solar panel is positioned on an area of the garment associated with the shoulder of a wearer of the garment.

6. The illumination system as recited in claim 5, wherein the one or more lights are mounted in an area of the garment associated with the torso of the wearer of the garment.

7. The illumination system as recited in claim 6, wherein the one or more lights are mounted on the garment in the form of a symbol.

8. The illumination system as recited in claim 1, wherein the one or more lights are configured to illuminate intermittently.

9. The illumination system as recited in claim 1, further comprising an ambient light sensor for alternately activating and deactivating the one or more lights responsive to detecting ambient light conditions.

10. An illumination system incorporated in a wearable article, comprising:
an article body configured to be worn on a human upper body;
a solar panel mounted on the surface of the body in an area associated with a shoulder of the wearer of the article body such that at least a portion thereof is exposed to ambient conditions, the solar panel being adapted to convert solar energy into electric energy;
a rechargeable battery for receiving electrical energy outputted from the solar panel mounted to the body;
one or more lights mounted to the body in an area associated with the torso of the wearer of the article body such that the light emitted from the lights is visible outside of the body when the lights are illuminated;
a switch mounted on the body and adapted to alternate between a connected and a disconnected position; and
a plurality of conductors in electrical communication with the solar panel, rechargeable battery, one or more lights and switch, wherein the conductors form an electrical circuit responsive to the switch being in the connected position.

11. The illumination system as recited in claim 10, wherein the one or more lights are mounted on the body in the form of a symbol.

12. The illumination system as recited in claim 10, wherein the one or more lights are configured in the form of a word.

13. The illumination system as recited in claim 10, wherein the rechargeable battery is one of a Li-battery, nickel-metal hydride battery, nickel-cadmium battery.

14. The illumination system as recited in claim 10, wherein the one or more lights are configured to illuminate intermittently.

15. The illumination system as recited in claim 10, further comprising an ambient light sensor for alternately activating and deactivating the one or more lights responsive to detecting ambient light conditions.
